(19) United States
(12) Patent Application Publication
(10) Pub. No.: US 2006/0010203 A1
(43) Pub. Date: Jan. 12, 2006

(54) Personal server and network

(75) Inventors: Janko Mrsic-Flogel, London (GB); Sakari Rahkila, Espoo (FI); William J. Yeager, Menlo Park, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/868,115

(22) Filed: Jun. 15, 2004

(51) Int. Cl. G06F 15/16

(52) U.S. Cl. 709/205

(57) ABSTRACT

Provided are improved systems and methods for networking and internetworking personal servers and associated end-user devices in a modified peer-to-peer (P2P) format, or Peerouette-Net. A personal server, or peersona, may be part of a network of peersonas where each peersona represents a user of the Peerouette-Net. Associated with each peersona are the devices of the user, or edge-peers, that communicate with the peersona and through the peersona as part of the Peerouette-Net. The Peerouette-Net is a modified P2P network in that it consists of two levels of connection between end-user devices, rather than one level of end-user devices. The software that executes in the peersonas rather than the software that executes in the edge-peers may facilitate the P2P nature and functionality of the Peerouette-Net.

### FIELD OF THE INVENTION

The present invention relates generally to systems and methods for network configuration and communications and, more particularly, to systems and methods for multiple-level peer-to-peer network communications where the peer-to-peer functionality of the network resides in personal servers or peersonas rather than in mobile devices intermittently connected to the network or non-mobile devices with stable network connections.

### BACKGROUND

Peer-to-peer (P2P) programs and P2P shared networks have recently increased in popularity, use, and reliance. Traditional P2P is a type of temporary network in which users connecting with one another through a communication network, such as the Internet, directly connect with one another's computers through a P2P application and transmit and receive various information, data, and files between the interconnected users. P2P networks are often described as file sharing networks and widely popular for sharing of MP3 files, but are used for many other purposes and with any type of file. Unlike a standard client/server model, traditional P2P denotes a shared network, in which personal computers directly connect with and search one another, where participants may be both suppliers and consumers of the information, data, and files of the network. P2P can be implemented by a method in which connections among individuals can be achieved with the aid of a server and by another method in which individuals share personal information, such as Internet Protocol (IP) addresses, and directly connect with one another without the aid of a server. Peers that connect with one another designate digital devices such as computers, Personal Digital Assistants (PDAs), mobile phones and the like as computers of the P2P network. Representative examples of such a P2P shared network are Napster, Soribada, and Kazaa. However, one problem with P2P networks are their temporary and ever-changing nature. A traditional P2P network in general is not persistent, but relies upon the end-user devices to form the P2P network which forms an ad-hoc network of user devices. As end-user devices come online and go offline, the P2P network changes. Reliability for sharing information is only as good as the status of the end-user devices being online to share their information. Furthermore, users of a P2P network cannot benefit from the existence of the P2P network unless the user has a device online functioning as part of the P2P network. Even P2P networks that use super-peers to moderate network behavior suffer from the instability of the reliability of the peers because, typically, the P2P software runs in the peer user devices. Thus, presence detection in traditional P2P networks is difficult and unreliable.

An added complexity of the growing popularity of P2P networks is the use of cellular telephones and other mobile terminals as end-user devices. Users of mobile devices are now able to access P2P networks. However, unlike devices which are connected to the network all the time (“always-on” or 24/7 devices), a mobile device only remains part of the P2P network as long as a wireless connection is provided between the device and the network. And due to limited cellular bandwidths, many users of mobile devices are restricted as users of P2P networks. This and other limitations of mobile devices as users of P2P networks reduces the overall efficiency and reliability of the network for all users where mobile users may connect to and disconnect from the network without remaining connected for long periods of time, permitting the network to benefit from the existence of another device on the network with which to share information, data, and files. Similar limitations exist for devices which are not cellular mobile devices where computers are connected to and disconnected from P2P networks, but with typically less frequency and longer durations due to common network connections such as fixed and/or always-on DSL and cable modem network access connections.

Another added complexity of traditional P2P networks is a user with multiple devices which may be mobile or situated in different geographical locations. Each device appears on the network as a different network node as if the user were multiple users each with one device. Even where a user has a device which is always-on, when the same user attaches another device to the network, the user is represented by two nodes. This device-independent characteristic of traditional P2P networks prevents a user from having a single personality on a P2P network and prevents the user from coordinating and combining information, data, and files of each of the devices of the user into a single entity or node on the network. Similar limitations restrict SMS and other network operations where a single user has multiple devices that may be used by the user to connect to one or more networks.

Accordingly, an improved personal server and associated network that can interface with a cellular network is needed for the networked and wireless industries and would benefit P2P networks with greater consistency and reliability, improve internetworking capabilities, and reduce and control bandwidth transmissions over networked and cellular systems.

### SUMMARY

In light of the foregoing background, embodiments of the present invention provide improved systems and methods for a personal server and associated network for P2P and cellular technologies.

Embodiments of the present invention improve upon existing P2P networks by providing an always-on, or 24/7, reliable two-stage network for P2P internetworking and end-user access. The present invention optimizes and personalizes the delivery of multimedia content to multiple user devices. The P2P network of the present invention may be used to provide a global P2P network (hereinafter referred to as the “Peerouette-Net”). By distributing the P2P network across two stages, a Personal Server layer and an edge-peer layer, the Peerouette-Net provides a hierarchy network for communicating and distributing data such as multimedia content and user services. The Personal Server layer maintains a consistent P2P infrastructure by providing persistent 24/7 uptime of entities representing users, or peersonas. A Personal Server provides the roll of both client and server, client to the P2P network and server to the end-user devices. The peersona is the presence of the associated user on the P2P network as exhibited through the Personal Server. The Peerouette-Net of the present invention may be incorporated within the infrastructures of wireless and broadband service providers. Further, embodiments of the present invention provide for secure and reliable communications, efficient network performance, and a new user experience while respecting copyright and other digital rights management controls.

An embodiment of a network of a system of the present invention may include at least two interconnected modulators each with at least one peersona and at least two edge-peers. Each of the edge-peers is associated with one of the peersonas of the modulators. In at least one embodiment of a network system of the present invention, at least one peersona is associated with at least two edge-peers. Similarly, a further embodiment of a network system of the present invention may include a plurality of edge-peers associated with a peersona. Similarly, an embodiment of a network system of the present invention may include at least one modulator that comprises at least two peersonas. A further embodiment may include a plurality of peersonas on a single modulator. In one embodiment of a network system of a present invention, at least one modulator is organized at a site, and at least two sites are organized into a region. One of the modulators of a site is a local modulator which coordinates communication within and between modulators of the site and provides routing within the site as a site routing authority. One embodiment of a network system of a present invention includes a region that comprises at least two modulators and a regional authority associated with the region and interconnected with each of the modulators in the region. Just as modulators may be organized into a site and sites organized into a region, one embodiment of a network system of the present invention includes at least two peersonas organized into a peersona community. One of the peersonas may be the creator of a peersona community. The creator of the peersona community may maintain the peersona community membership list and such a list may be inspected by other peersona community members.

An embodiment of a peersona system of the present invention may include a modulator, a peersona, and at least one edge-peer. The peersona is stored on the modulator, and the edge-peer is associated with the peersona. In a further embodiment of a peersona system of the present invention, at least some of the content for the edge-peer is stored on the modulator in the peersona. At least some of the content may be stored in a content escrow of the peersona. The content in the content escrow may be stored pending digital rights management clearance for access or sharing of the content. An edge-peer and a peersona of a peersona system of the present invention may be able to communicate using a peersona-edge-peer communication protocol. An edge-peer of a peersona system of the present invention may be a mobile phone, a pager, an electronic gaming system, a portable multimedia system, a personal music system, a personal digital assistant, a personal portable electronic device, a personal computer, a set top box, a television set, or other dedicated functionality device.

An embodiment of a modulator system of the present invention includes memory, a processor, a network connection, and at least one end-user device connection. The memory is segmented to store data representing at least one user entity or peersona. The processor is coupled to the memory and generates a network connection for transferring information to and from end-user devices. An embodiment of a modulator system of the present invention may further include a site-wide modulator map that lists the active modulator bindings at the site of the modulator system. An embodiment of a modulator system of the present invention may further include a bandwidth monitoring module to monitor and record bandwidth usage of the network in the end-user device connections.

An embodiment of a method of performing networking of the present invention may include the steps of creating a plurality of peersonas, internetworking modulators, and associating at least one edge-peer with each of the peersonas. Each of the peersonas represents one user of a network, and each peersona is resident on a modulator. One embodiment of a method of performing networking of the present invention includes the step of dividing computer program code for an application or a service of one of the edge-peers between the edge-peer and the peersona associated with the edge-peer. One embodiment of a method of performing networking of the present invention further includes the steps of distributing updated computer program code to modulators and updating computer program code of at least one peersona using at least a portion of the updated computer program code. Updating computer program code of at least one of the peersonas updates or upgrades at least a portion of divided computer program code for an application or a service of the peersona where an associated edge-peer includes at least a portion of divided computer program code for the same application or service. At least a portion of such divided computer program code resident on the edge-peer associated with the peersona may be updated for the same application or service. Additionally or alternatively, the operating system of the edge-peer or the communication protocol between the edge-peer and the associated peersona may be updated. A further embodiment of a method of performing networking of the present invention may include the steps of distributing updated computer program code to modulators, updating computer program code of peersonas using at least a portion of the updated computer program code, and updating computer program code of at least one edge-peer using at least a portion of the updated computer program code. A further step of inspecting version information of computer program code of edge-peers may be performed to determine whether computer program code of the edge-peers is to be updated.

One embodiment of a method of performing networking of the present invention includes the step of performing configuration management of at least one modulator, peersona, or edge-peer. Configuration management may include deploying application or service computer program code where modifying at least one setting. Deployed computer program code may be an application or service computer program code, an associated data item, an operating system for an edge-peer, or a communication protocol between an edge-peer and an associated peersona.

In one embodiment of a method of performing networking of the present invention, peersonas may communicate when at least each of the edge-peers associated with one of the peersonas is temporarily disconnected from or unavailable to the peersona. Peersonas, of either the same or of different modulators, may communicate with each other regardless of whether associated edge-peers are currently available to the peersonas. All such communication between peersonas may take place in a peersona community. One embodiment of a method of performing networking of the present invention includes the step of distributing at least one data file to at least one of the modulators, peersonas, or edge-peers. The data file may be multimedia content or information associated with digital rights management of a user.

In one embodiment of a method for performing networking of the present invention, peersonas may determine the source of a data file using a peersona silent chat protocol in a peersona community.

One embodiment of a method of performing networking of the present invention includes the step of backing up one of the edge-peers onto an associated peersona to create a backed-up edge-peer. Using the backed-up edge-peer, an edge-peer, either the original backed-up edge-peer or a different edge-peer, may be restored from the peersona.

One embodiment of a method of performing networking of the present invention includes the step of requesting a site-wide modulator map. Another embodiment of a method of performing networking of the present invention includes the step of requesting notification from a central host of registration of other modulators at the site of the requested modulator when there are no other registered modulators at the site of the requested modulator. A further embodiment of a method of performing networking of the present invention includes the step of messaging a sequential keep-alive token ring of modulators to update the site-wide modulator map at each of the modulators. The sequential messaging may begin either with notification of a central host to a registered modulator of registration of a modulator, or periodically by a registered modulator.

These characteristics, as well as additional details, of the present invention are further described herein with reference to these and other embodiments.

### BRIEF DESCRIPTION OF THE DRAWING(S)

Having thus described the invention in general terms, reference will now be made to the accompanying drawings, which are not necessarily drawn to scale, and wherein:

FIG. 1 is an embodiment of a peersona of the present invention;

FIG. 2 is an embodiment of a Peerouette-Net of the present invention;

FIG. 3 is an embodiment of modulator-to-modulator communication of services across the Peerouette-Net of the present invention;

FIG. 4a is an embodiment of the separation of an association of a peersona community of the present invention;

FIG. 4b is an embodiment of a peersona community of the present invention;

FIG. 4c is an embodiment of the mapping of a peersona community of the present invention;

FIG. 5 shows peersonas, sites, and regions of the Peerouette-Net of an embodiment of the present invention;

FIG. 6 shows peersonas, sites, regions, and a peersona community of the Peerouette-Net of an embodiment of the present invention;

FIG. 7 is a modulator keep-alive token ring of an embodiment of the present invention;

FIG. 8 is a diagram of a peersona and a diagram of communication between peersonas of an embodiment of the present invention;

FIG. 9 is a device connection portal using web access to a peersona of an embodiment of the present invention;

FIG. 10 is a community, device connection, and services and application portal of a peersona seen from a Personal Server Management Console of an embodiment of the present invention;

FIG. 11 is an acceptance portal of a device connection to a peersona of an embodiment of the present invention;

FIG. 12 is a device connection portal requesting a peersonaIdentity and password for connection to a Personal Server of an embodiment of the present invention;

FIG. 13 is a block diagram of two stages of the process of service or content configuration of an embodiment of the present invention;

FIG. 14 is a block diagram of two stages of computer program code updating and service configuration management of an embodiment of the present invention;

FIG. 15 is a request to backup an end-user device onto a Personal Server of an embodiment of the present invention;

FIG. 16 is a status view during backup of an end-user device onto a Personal Server of an embodiment of the present invention;

FIG. 17 is a block diagram of a backup of an end-user device onto a Personal Server of an embodiment of the present invention;

FIG. 18 is a block diagram of a restoration of an end-user device from a Personal Server of an embodiment of the present invention;

FIG. 19 is a block diagram of Personal Servers communicating for application execution or providing services for peersonas while end-users and end-user devices of the peersonas are unavailable according to an embodiment of the present invention;

FIG. 20 is a block diagram of an edge-peer of a peersona becoming active on a Personal Server of an embodiment of the present invention;

FIG. 21 is a block diagram of an entity capable of operating as an entity of a Peerouette-Net of an embodiment of the present invention; and

FIG. 22 is a block diagram of a mobile terminal capable of operating as an edge-peer of an embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

While a primary use of the present invention may be in the field of mobile phone technology, it will be appreciated from the following description that the invention is also useful for many types of devices that are generally referenced herein as mobile terminals, including, for example, mobile phones, pagers, handheld data terminals and personal data assistants (PDAs), portable medical devices, personal multimedia units and music systems such as video or audio players (e.g., MP3 players), portable personal computer (PC) devices, electronic gaming systems, global positioning system (GPS) receivers, and other portable electronics, including devices that are combinations of the aforementioned devices. Similarly, one of ordinary skill in the art will recognize that, while the present invention is particularly useful for mobile and wireless devices, the present invention can be used with other devices and systems, such as desktop personal computers (PCs), televisions and television control boxes such at set-top boxes, and other dedicated devices that may benefit from internetworking associated with a particular user including smart devices such as refrigerators, electronic white boards, security systems, various sensors or imaging devices, and cars.

In embodiments of the present invention, a user is assigned or ‘owns’ a Personal Server which stores and represents the user's “peersona” on a network. A Personal Server may be embodied as a software bundle, typically including a collection of services and agents that represent the user, deployed on a server hardware platform, or modulator. Because a modulator may be embodied as an always-on server, the user's Personal Server, or peersona, may also be available 24/7. Together, the Personal Server and end-user devices, or edge-peers, are able to manage applications and services for network functionality and content data and data files such as electronic messages such as SMS, EMS, MMS, or electronic mail, VoIP, and multimedia content such as movies and audio. The peersona is the point of first contact for P2P communication. A peersona and an edge-peer may communicate using a peersona-edge-peer protocol such as a small protocol handler that may be configured to minimize bandwidth communication between the Personal Server of the peersona and the edge-peer.

Applications and services may be split in functionality between the Personal Server and edge-peers associated with the Personal Server. By splitting the functionality, and associated computer software code and processing, each application and service can be optimized in various manners such as to reduce bandwidth between a Personal Server and an edge-peer, minimizing computer program code storage on an edge-peer, and simplifying application and services computer program code update or upgrade by increasing such activity on a Personal Server and decreasing such activity on edge-peers. For example, a software application resident on a Personal Server may be upgraded on the Personal Server without needing to upgrade any software application or related computer program code on the edge-peer, thus, greatly simplifying the process of disseminating updates and performing updates of computer program code. This split application and service functionality is referred to as Peered Device Service Configuration, referring to the configuration of what elements of an application or service are executed, stored, etc. on an edge-peer or a Personal Server.

Further, because a Personal Server runs 24/7 on a modulator, functions may be invoked by and/or for a peersona of a Personal Server even when all associated end-user devices, or edge-peers, are switched off or otherwise unavailable or disconnected (offline) from the Personal Server and the network. Thus, a Personal Server and the peersona that it represents may remain on a network for communicating with other Personal Servers and their respective peersonas on behalf of the users of the peersonas while the users may be away and while the edge-peers of the users may be offline. The separation between a peersona of a P2P network and the end-user devices of the peersona also permits a user to have improved mobility since the user can always contact his or her peersona on the network regardless of location, such as when traveling. A Personal Server and a peersona refer to the same network entity, although the two terms have been used separately to aid in understanding of a hardware and software aspect of a peersona of the present invention (generally referred to as a Personal Server) by comparison to a network entity aspsect of a peersona of the present invention (generally referred to as a peersona). Therefore, any collective references to the two terms does not refer to the two terms as separate devices or entities but as one peersona which may be though of as being embodied by a Personal Server of a Modulator or other hardware and software device. A Personal Server may be referred to herein to represent a network entity of peersona or of a user in accordance with the present invention. Similarly, a peersona may be referred to herein to represent a hardware or software element of a network entity of a user of a peer-to-peer network in accordance with the present invention.

The Personal Server provides a central personal data repository for holding content files such as movies, audio, and text. Thus, a user is able to build a single peersona for all of the content of the user, independent of a particular device used by the user. In similar fashion, the Personal Server can also be used to backup end-user devices onto the Personal Server and provide device restoration from the Personal Server. For example, if a user loses a mobile phone, the user can restore the last available backup of the lost phone from the Personal Server onto a new mobile phone. The Personal Server also provides the ability to perform configuration management of applications and services such as by changing settings required for an application or service, deploying software, and updating or upgrading computer program code. Configuration management may even perform updating or upgrading of operating systems on edge-peers. A Personal Server may also store digital rights information for a user such that a user may be able to access content available in the digital rights catalog of the user on any of the edge-peers of the user. Thus, digital rights management (DRM) may be preserved, and even efficiently and seamlessly extended to new uses, devices, and contents. For example, an escrowed storage may be used on a Personal Server for downloaded content not available in the digital rights catalog of a user stored in the peersona of the user. Upon obtaining digital rights for the content, the content may be moved from escrow storage on the Personal Server of the user to the content storage for the user to allow the user to manage and/or view or otherwise access the content such as through an edge-peer.

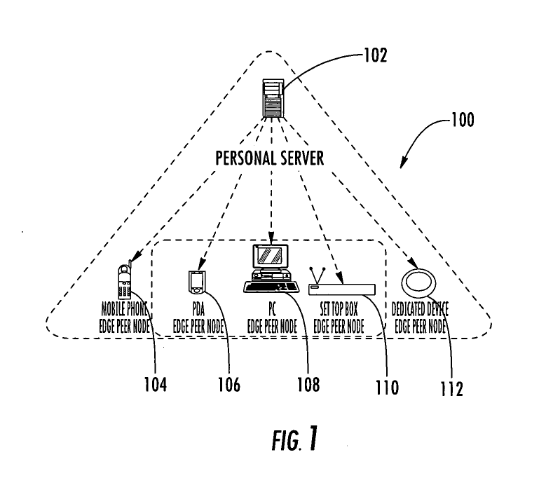

FIG. 1 is an embodiment of a peersona of the present invention. In simplest form, the building blocks of the present invention are peersonas. A peersona 100 is the presence of an associated user on a P2P network as exhibited through a Personal Server 102. The Personal Server 102 is connected to different devices of the user such as a mobile phone 104, a personal digital assistant (PDA) 106, personal computer (PC) 108, television set top box 110, and dedicated devices 112. Each of these user devices may be referred to as an “edge-peer”. The user's profile or entity presence on the Personal Server 102 creates the peersona 100 of the user as a perceived network presence of the user. A peersona is a user's private, personal agent acting on behalf of the user on a network such as a P2P network. Thus, when referring to a peersona, the reference is implicitly referring to the user. The combination of all of the user's edge-peers may be described as the user's device family. A user may have any number of edge-peers associated with the user's Personal Server as part of the user's peersona. A dedicated device or dedicated edge-peer generally has a single purpose such as a home gateway, a GPS receiver, or an MP3 player, unlike a mobile phone or a personal digital assistant which may be used for multiple purposes. The differentiation between a single purpose and a multipurpose device is irrelevant to the use of the device as an edge-peer associated with a Personal Server of a peersona.

FIG. 2 is an embodiment of a Peerouette-Net of the present invention. Example layers of an embodiment of a Peerouette-Net 120 of the present invention are shown on the left side of FIG. 2. The bottom layer or user layer 122 represents the users of the Peerouette-Net, specifically the end user 140 of devices or edge-peers of the Peerouette-Net 120. Above the user layer 122 is the edge-peer layer 124 which includes each of the end-user devices or edge-peers 142, 146 associated with Personal Servers 176, 178, 180, 182 of peersonas 188, 190, 192, 194. An edge-peer 142 may be used by a single user or may be a multiple-user device 146 such as a television set top box used by two users of a family which may be associated with the peersona of each member of the family. A multiple user device 146 may be associated with a single Personal Server or may be associated with multiple Personal Servers (not shown). Above the edge-peer layer 124 is the Personal Server layer 126 including the Personal Servers associated with the edge-peers 142, 146. A collection of Personal Servers 176, 178, 180, 182 may be referred to as a Peerouette-Network or Peerouette-Net 184. More broadly the entire network including peersonas regional authorities, management systems, bill payment systems, hosting management, and other services, applications, and content servers may be included as part of the general or overall Peerouette-Network. By analogy to a traditional peer-to-peer (P2P) network, the Peerouette-Net would refer to simply all of the Personal Servers in such a manner as to capture each of the peersonas of the users of the network. For example, the collection of Personal Servers 176, 178, 180, 182 provides a Peerouette-Net of users 140 for each of the associated peersonas of 188, 190, 192, 194 of the users 140. Above the peersona server or Personal Server layer 126, are additional network support layers for such services and management as billing and routing. As shown in the embodiment of FIG. 2, a local level node layer 128 includes peersona regional authority local routing servers and web service servers 172, 174. The regional authority servers 172, 174 provide routing and other services to peersonas or Personal Servers in the respective region of the peersona regional authority. For example, a region 186 is controlled by a regional authority 172 over Personal Servers 176, 178. Higher layers such as mid-level nodes 130 and top-level nodes 132 may further coordinate communications with and between regional authorities of the Peerouette-Network. A service provider layer 134 may include a content provider or other type of content service provider or root node. A content provider server 164 may be part of a Peerouette-Net controlled by a wireless or broadband service provider or may be an external content provider. If the content server 164 is an external content provider, a content services authority 158 may control the content provided by the external content provider to the Personal Servers of the Peerouette-Network. A Peerouette control systems layer 136 may include a peer central peer management system and web service 154, a community central community naming authority web service 156, peersona services central services authority web service 158, hosting central server management web service 160, and a peersona service root node 162. These Peerouette control system layer servers provide different functionality associated with the Peerouette-Net, Peerouette-Net supporting server layers, and relationships with external parties. A Peerouette internal systems layer 138 may include a billing central billing payment system web service 150 and a central certificate authority web service 152. These and other functions and servers are described further herein with reference to these servers.

As visible from the embodiment of FIG. 2, a Personal Server may be both a client and a server providing server services to edge-peers and client and server services to other Personal Servers and higher layer servers such as regional authorities, content providers, and hosting central servers. By using Personal Servers to represent peersonas on the Peerouette-Net, the Peerouette-Net provides a peer-to-peer network which is device independent. That is, the edge-peers do not need to be connected to or available to the Personal Servers for the peersonas of the users to exist on the network and interact with other peersonas and network control servers. The Personal Servers allow for an infrastructure that provides a persistent, 24/7 uptime of Personal Servers or peersonas for each user.

One or more Personal Servers or peersonas may appear on a single machine referred to as a Peerouette-Net modulator or simply a modulator. For example, Personal Server 176 and Personal Server 178 of FIG. 2 may actually reside on the same modulator. By comparison, Personal Server 180 and Personal Server 182 may appear on two separate modulators. Any number of multiple peersonas may reside on a single modulator. Modulators may be grouped at sites or geographic locations where the modulators may be directly connected or inter-networked. The use of modulators is primarily designed for hardware requirements to reduce the number of hardware servers which are used to store each of the peersonas of the Peerouette-Net. Further, by using a single modulator to represent multiple Personal Servers or peersonas, the communications between peersonas may be condensed in such a manner as to reduce the physical locations of hardware to which communication interfaces may need to be available. Further, by using modulators the support services for Personal Servers may be condensed such as by reducing the number of machines to which an update or upgrade of computer program code would need to be distributed and executed or reducing the size of and streamlining the maintenance of local, site-wide modulator maps. Several modulators or sites of modulators may be organized into regions such as a region 186 representing a collection of Personal Server 176 and Personal Server 178 under the control of peersona regional authority 172. The regions are used primarily for simplification of routing of communication between peersonas and the associated modulators of peersonas. Thus, one may view the broad or more general Peerouette-Network as a geographically defined collection of modulators and the associated peersonas of the modulators into sites and regions. However, the organization and internetworking of the broader Peerouette-Network is simply provided for the ability of the Personal Servers of each of the peersonas to be able to communicate efficiently with all of the other Personal Servers on the Peerouette-Network. As described as geographically defining a collection of modulators, a site may be a city, a part of a city, several villages, a county, a department of a company, a company, or any other type of associated region whether business or physical. The organizational architecture of the Peerouette-Network into sites of modulators is intended to maximize the efficiency of communication when the expectation is that most communication will be site-local such as through communication between modulators of a single site. Although, the Peerouette-Net is built in regions to provide for efficient communication between sites in the same region and for communication with Personal Servers in other regions. One of ordinary skill in the art will recognize that the organizational architecture of the Peerouette-Net may be comprised of any organized structure of Personal Servers or modulators that provides for efficient communication between Personal Servers or peersonas of the Peerouette-Net.

Each entity in the broader Peerouette-Network maintains a unique identity to provide for routing of communications between Personal Servers and between control servers and Personal Servers or modulators of the Peerouette-Network. For example, each peersona is assigned a peersonaIdentity; each modulator is assigned a modulatorIndentity; each site is assigned a peerouetteSiteIdentity; and each region is assigned a regional Peerouette-Net authority identity or RPNAIdentity (RPNAID). Devices which have associated IP addresses would have a binding between the Peerouette-Network unique identification and the IP address of the device, such as {RPNAIdentity, RPNA IP-address} and {modulatorIdentity, modulator IP-address}. A peersona only needs to know its peersonaIdentity because its communication is regulated by its modulator. Modulators may likely have knowledge of all other modulators at its site and knowledge of the peerouetteSiteIdentity of its site and the RPNAIdentity of its region, as well as the IP-address of such identifications. Each regional Peerouette-Network authority (RPNA) has knowledge of the RPNAIdentity other regional Peerouette-Net authorities, as well as the IP-address of such devices. A Peerouette-Network Router Central or Hosting Central server may provide such RPNAIdentity and IP-address combinations and/or other identification information. For example, regional Peerouette-Network authorities may also maintain routing tables for sites, modulators, and/or peersonas. These tables may be generated by the network or maintained from activity between regional Peerouette-Network authorities and sites, modulators, and/or peersonas. Through bindings, an IP address of a modulator, and, thus, a peersona, may be acquired from a lookup of its Peerouette-Network Identity, and the reverse, such that information, data, or content sent to an IP address on the Peerouette-Network may be delivered at the appropriate server or peersona.

By comparison to a traditional P2P network, each edge-peer of a traditional P2P network would be uniquely identified on the network, but in the Peerouette-Network of the present invention, peersonas are provided the unique identities for user entities of the P2P network. This provides gains of performance and reliability of the Peerouette-Net because the Peerouette-Net is not affected by the reliability or accessibility of the edge-peers of the user. Peersonas, or more particularly, Personal Servers may be highly available, 24/7 servers on ethernets with bandwidths in excess of one gigabit per second (Gbps) or more as technologies improve. As such, the P2P network of the present invention represents peers as always-on peersonas rather than accessibly intermittent end-user devices. Thus, a user in the Peerouette-Net is always present by the user's peersona. Therefore, a peersona, or personal agent of the user, may be working on behalf of the user as a peer in the Peerouette-Net on a 24/7 basis regardless of whether the user is connected to the Peerouette-Net or a device of the user is connected to the Personal Server of the user.

In one embodiment of a method for performing networking of the present invention, peersonas may determine the source of a data file using a peersona silent chat protocol in a peersona community. To accomplish a silent chat session, a silent chat service may be enabled in each peersona. For each persona, this service may awaken or cycle on a periodic timer to establish a temporary communication, or silent chat, session with a known and unique silent chat session identifier for the peersona community. If a session is already active, then the peersona may register itself as a member of this session. Otherwise, the peersona may initiate a session and registers itself. This registration may take place at a modulator determined by the silent chat session identifier. After a suitable number of peersonas have registered for the silent chat session, the list may be closed and there may be no further additions until the next silent chat cycle is initiated on the next wake-up or cycle timer. In this manner a pseudo-random list of peersonas may be generated in selected peersona communities. The modulator hosting the silent chat session may be queried for the list, and this list may then be used to select the sources of content that is well distributed in the peersona community such as highly popular content. The term ‘silent chat’ is used because a similar mechanism can be used to initiate true chat rooms.

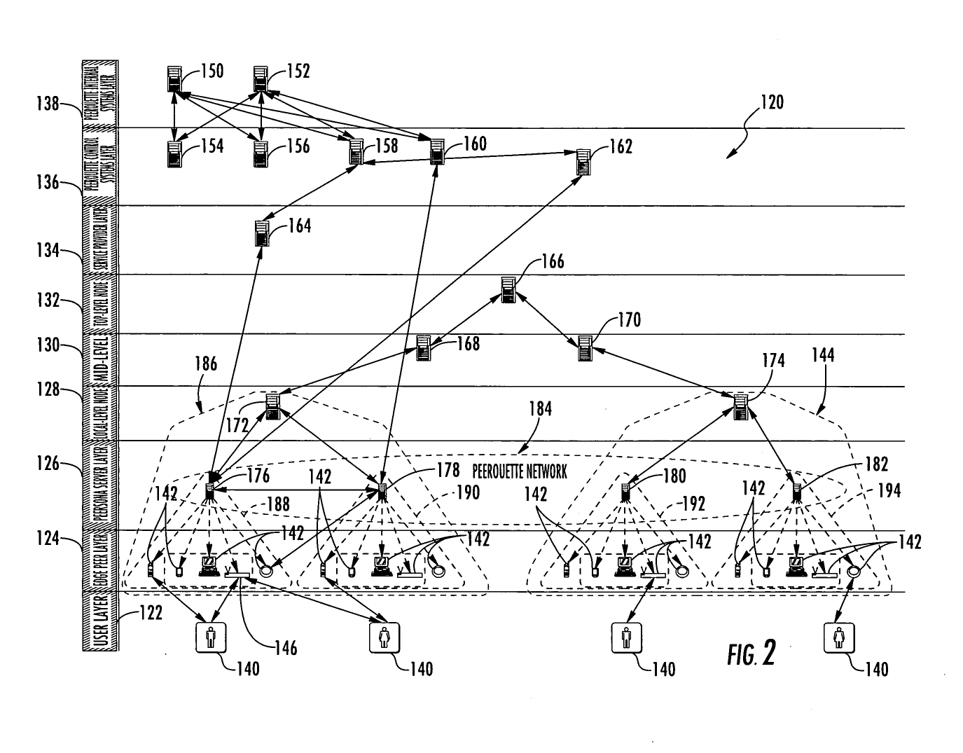

FIG. 3 is an embodiment of a modulator-to-modulator communication of services across the Peerouette-Net of the present invention. Two modulators 202, 204 are shown connected through the Peerouette-Net 200. By using a single modulator for representation of multiple peersonas, a modulator is able to perform various services across a modulator layer before presenting such services into the Personal Servers or peersonas of the modulator. For example, a modulator 202, 204 may perform various services 206 by and for peersonas 208 and communicate such services, if necessary, across the Peerouette-Net 200. For example, a modulator may transcode content for consumption by an edge-peer of a peersona associated with the modulator or another modulator. Transcoding typically describes the process of converting one media or other content data format to another media or other content data format. Transcoding more generally refers to decoding one coding scheme and encoding with another coding scheme.

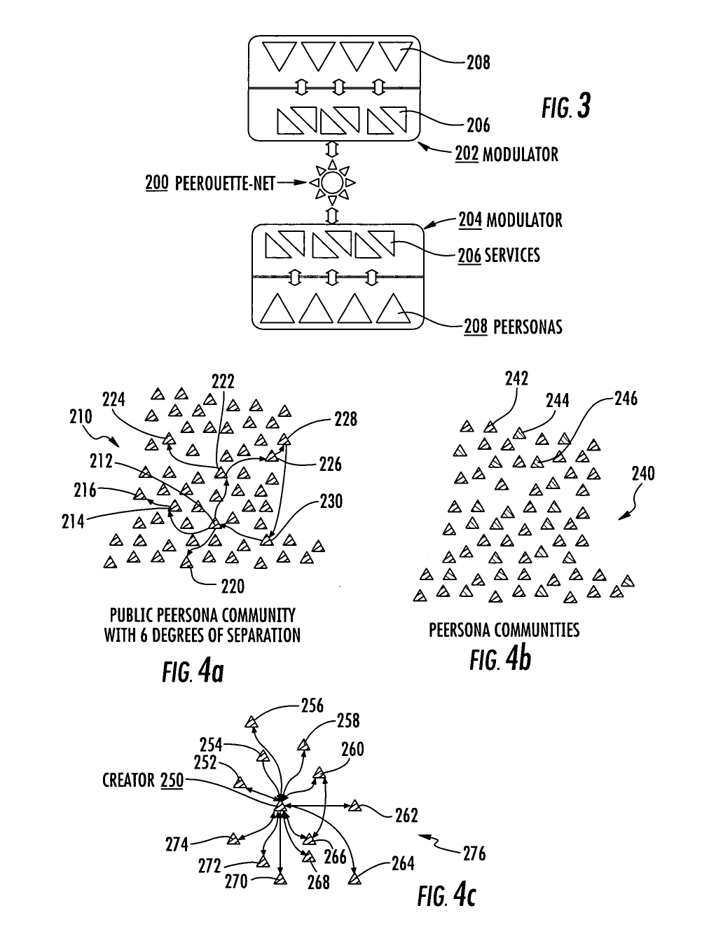

FIG. 4a is an embodiment of the separation of an association of a peersona community of the present invention. Peersonas may be organized into communities or associations of related interest, relationships, or various other organizational factors. For example, peersona communities 242, 244, 246 are represented for a sample of peersonas 240 in FIG. 4b. The concept of P2P networking involves the ability to find a peer within the network or among a community. Without communities, peers are generally referred to being related by six degrees of separation, meaning it may require as many as five points of contact to identify a peer such that the sixth contact is the requesting peer. This concept is just a generalization for the breadth of difficulty presented to contact or find another peer in a traditional P2P network. By comparison, as shown in FIG. 4c, by creating peersona communities with a single peersona creator 250 which creates and maintains the community, any peer may identify another peer within the community by contacting the creator peersona 250 to identify another peer within the community. For example, peersona 260 may contact the creator peersona 250 to determine the identity of peersona 268 within the peersona community 276. This organization of a peersona community provides a “one-hop” or single contact point discovery of peersonas in the community.

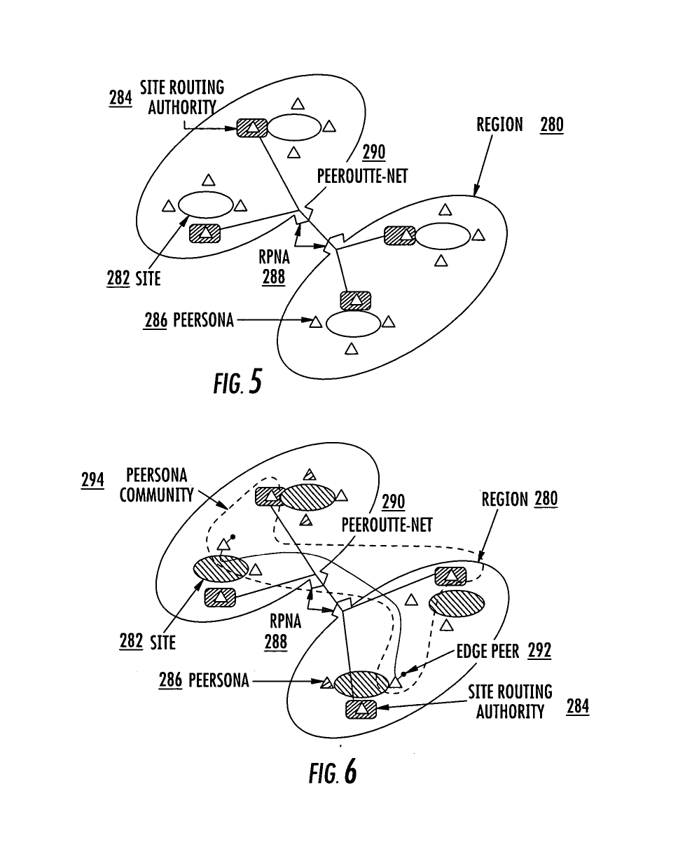

While peersonas may be organized into communities, Personal Servers and modulators are organized into sites 282 and regions 280 as shown in FIGS. 5 and 6. FIG. 5 shows peersonas, sites, and regions of a Peerouette-Net of an embodiment of the present invention. FIG. 6 shows peersonas, sites, regions, and a peersona community of the Peerouette-Net of an embodiment of the present invention. The peersona community 294 of FIG. 6 translates across the regions 280 to capture peersonas 286 of both regions. The peersona community organizing architecture is unrelated to the local and regional organization structure of sites and regions for routing. Rather, the local and regional organizational architecture of the Peerouette-Net provides for the routing of information between peersonas within and without sites and regions. For example, a regional Peerouette-Net authority (RPNA) 288 is used to transmit and receive routing information from and to its region of control. A site routing authority 284 is used to advertise the routing information required to contact and transmit messages to and from the modulators within the site. Further, a site routing authority 284 would control the routing of transmissions between modulators within the site. And a regional Peerouette-Net authority 288 would control routing of transmissions between modulators of sites in its region. By way of example, an edge-peer 292 contacts its peersona 286 to transfer or receive information to or from the network. The peersona 286, by way of its Personal Server, uses its modulator routing services for transferring information to and from the Personal Server. The modulator contacts its site routing authority 284 for routing of information to and from the modulator. The site routing authority 284 contacts the regional Peerouette-Net authority 288 for routing information required for the transfer of information to and from the site. Once a peersona acquires the fully qualified Peerouette-Net address and, therefore, route to a destination peersona in this manner, the peersona will have the IP address and port of the ultimate destination peersona and can transfer content directly to that peersona. If the destination is an edge-peer, then the content will arrive to a data message memory (Inbox) relative to the peersona community and/or service to which the edge-peer belongs and in which the edge-peer is active. Using an edge-peer to peersona protocol, the edge-peer can retrieve the content from the Inbox. Alternatively, for non-mobile edge-peers such as set top boxes, a Service Rendezvous Protocol between such an edge-peer and the destination peersona may yield the IP address and port of the destination edge-peer if direct communication is possible. In this instance, once this address is known, the content may be transferred directly to the destination edge-peer.

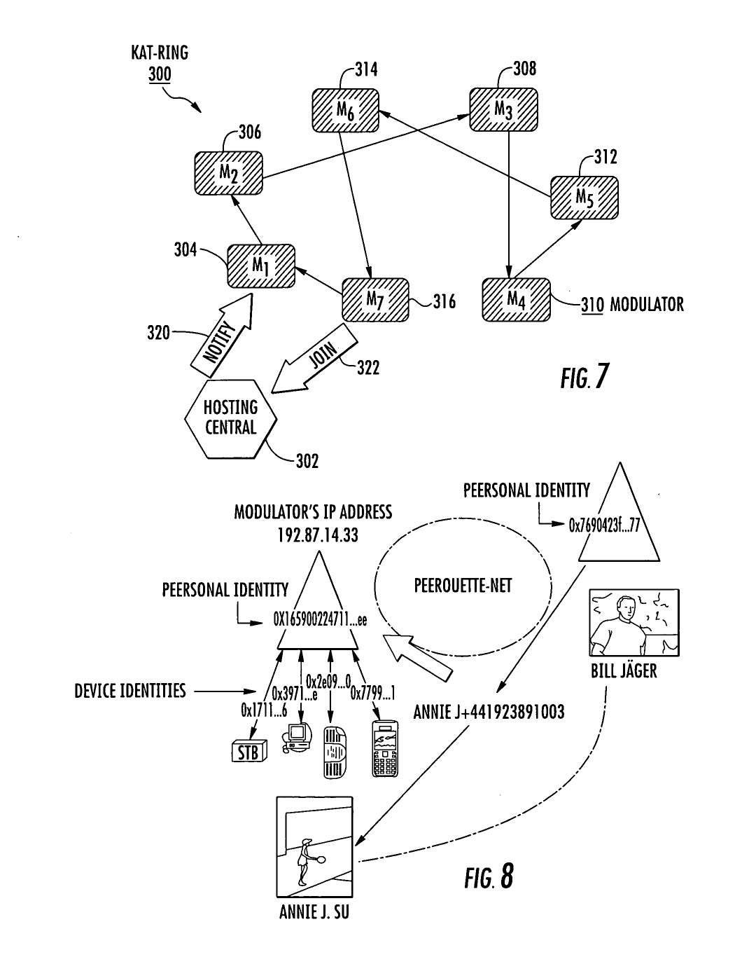

FIG. 7 is a modulator keep-alive token ring of an embodiment of the present invention. Each modulator maintains a site-wide modulator map of the registered and active modulators in the site. A hosting central server may be used to create and maintain a site-wide modulator map. For example, each time a new modulator joins a site, the hosting central server may notify one of the modulators, typically the site routing authority modulator, that a new modulator has joined the site. Then, in order to maintain up-to-date site-wide modulator maps throughout the modulators in the site, a keep-alive token ring (KAT-Ring) is used to sequentially notify each of the modulators registered in the site that a new modulator has joined the site via the hosting central server. The site-modulator map is essentially a list that provides the modulator identity and internet protocol (IP) address for each of the modulators in the site. The site-modulator map may also include information regarding the status of each of the modulators in the site, such as whether or not the modulator is active, new, shutdown, off-line, not-responding, unknown, or the like. The keep-alive token ring is a mechanism by which the modulators in the site may verify the site-wide modulator map with a minimum of network activity. A keep-alive token ring may also be used such as to notify modulators of a change in system status, when, for example, a modulator is required to temporarily go off-line for maintenance. When a new modulator attempts to register or join a site, during the boot or registration sequence, the modulator 316 may contact the hosting central services server 302 to register the presence of the new modulator 316 in a given region at a particular site as a binding of its modulatorIdentity with its IP address. At the same time, the new modulator 316 may request a list of active modulator bindings at this site. This requested list is the site-wide modulator map. Generically, the site-wide modulator map would include the following information: {{modulatorIdentity₀, IP address₀}, . . . , {modulatorIdentity_{N}, IP address_{N}}} for all of the modulators in the site. If there are no other registered modulators at the site, the new modulator 316 may request a notification from the hosting central server 302 of any change of state of the active or registered modulators at the site. Thus, by notification from the hosting central server 302, modulators within the site are able to acquire knowledge of the existence of other modulators in the site. When a new modulator comes online at the site by registration with the hosting central server 302, the hosting central server 302 may notify one of the modulators in the site, such as the modulator 304 with the smallest modulatorIdentity such as the modulator that has been registered first at the site. To maintain the site-wide modulator presence information in the site-wide modulator map, the modulators will then use the keep-alive token ring. The keep-alive token ring may be a periodic modulator-to-modulator message that uses the acquired site-wide modulator map as an itinerary of subsequent modulators that are contacted to update the site-wide modulator map. Because embodiments of the present invention include modulators which would typically be controlled by a wireless or broadband service provider and provide always-on, 24/7 services, it is expected that the modulator site-wide map will quickly reach stability and rarely change barring hardware failure, the addition of new modulators, a modulator going off-line temporarily, or the removal of an existing modulator. A keep-alive token ring message will contain information about the known modulators at the site. Any changes to the modulators would be marked within the message such as new, shut-down pending, off-line, not-responding, unknown, and the like. This type of modulator information may be identified as the state of the modulator in the keep-alive token ring message. By comparison of the state and information provided in the keep-alive token ring message to the site-wide modulator map at the modulator, a modulator may identify if there has been a change in the site-wide modulator map. Further, to preserve security, such as to prevent denial of service (DoS) attacks, each modulator may be issued a certificate by a certificate authority central server, and each modulator may sign any changes to the keep-alive token ring message with its respective certificate that may be verified by a hosting central server or other modulators which have been provided the certificates of the other modulators in the site by the certificate authority central server. Thus, at least the hosting central server, if not each of the modulators in the site, may verify that any changes to the keep-alive token ring message provide accurate information about changes in the site-wide modulator map. For example, given a list of active modulators, M₀, . . . , M_{N}, the hosting central server 302 may notify 320 the first-registered modulator M₁ 304 of the change of status of the site-wide modulator map to include the registration of a new modulator M₇ 316 as joining the site. After receiving the notification and noting such change in the site-wide modulator map, the first modulator M₁ 304 would then present the keep-alive token message to the subsequent modulator M₂ 306 which would then present the message to the subsequent modulator M₃ 308 which presents the message to subsequent modulator M₄ 310 which presents the message to subsequent modulator M₅ 312 which presents the message to subsequent modulator M₆ 314 which presents the message to the newly joined modulator M₇ 316. Upon receipt of the message by newly joined modulator M₇ 316 and identification of the change in status of the site-wide modulator map as being the registration of modulator M₇ 316, the modulator M₇ 316 could terminate the keep-alive token ring message by sending the message to the original modulator M₁ 304. By way of example, if M₁ 304 is down, then M₇ 316 may note that M₁ 304 is down. M₂ 306 may reinitiate the KAT-Ring, and M₁ 304 may add the state of ‘not-responding’ for M₁ 304 upon reception of the keep-alive token ring message if M₁ 304 still appears to be down.

Additionally or alternatively, a keep-alive token ring message may be initiated by a modulator such as a routing authority modulator or the first-registered modulator. By periodically circulating a keep-alive token ring message, the modulators in the site are able to continuously monitor the status and activity of the modulators present and registered in the site. Modulators may use this periodic keep-alive token ring message as a means to identify the other modulators in the site that a modulator may be temporarily off-line and to notify each of the modulators in the site when a modulator has come back online. Further, if a modulator in the keep-alive token ring crashes, thereby preventing the transmission of a periodic or hosting central server initiated keep-alive token ring message, a subsequent modulator in the keep-alive token ring sequence may initiate a keep-alive token ring message after not receiving a message for a period of time such as one and one half times the standard periodic time between keep-alive token ring messages. The subsequent modulator beyond the modulator that has crashed would likely mark the previous modulator with a status of not-responding which may be used by the hosting central server to investigate whether or not the unknown modulator has crashed, is available, is online, or any other status. For example, if the hosting central server receives a keep-alive token ring message identifying the status of a modulator as not-responding, the hosting central server may attempt to communicate with the not-responding modulator to identify whether it is off-line, and if so, mark the status of the not-responding modulator as being off-line and recirculate a keep-alive token ring message to allow each of the other modulators in the site to update the site-wide modulator map with the status of the previously not-responding modulator as currently being off-line. If the hosting central server is unable to contact the not-responding modulator, the hosting central server may be able to notify a higher authority such as a human to further investigate the not-responding status of the modulator. For example, the hosting central server may launch a Java™ mobile agent that can ping the not-responding modulator from a random set of modulators not including the not-responding modulator. If the attempt to contact the not-responding modulator is unsuccessful, then the hosting central server might notify a human. Typically, if a modulator is unable to contact the next hop or subsequent modulator to pass a keep-alive token ring message, this information is added to the data of the message such as by changing the status of the subsequent modulator as not-responding, and the modulator would then pass the keep-alive token ring message to the second subsequent modulator in order to continue to sequence the keep-alive token ring message around the modulators of the site.

FIG. 8 is a diagram of a peersona in communication with another peersona of an embodiment of the present invention. As previously mentioned each peersona is provided an identity or unique identifier for the user. This unique identifier of the peersona is the peersonaIdentity that is used by the modulator to provide routing information for other modulators, site routing authorities, and regional Peerouette-Net authorities. Further, each edge-peer of a user is provided an edgepeerIdentity. These identities may be machine generated by a Peerouette-Network control server such as a hosting central server or a central certificate authority server, thus ensuring that each of these identities is guaranteed to be a universal unique identifier (UUID). Alternatively, either a secure or pseudo random number generator may be used to generate universal unique identifiers twenty bytes in length that are guaranteed to be statistically unique. FIG. 8 provides an example peersona for Annie J. Su and communication between the peersonas of Annie J. Su and Bill Jäger. The name, nickname, or handle, for the peersona of Annie J. Su may be represented as AnnieJ if such name is uniquely available. A unique and personal identifier such as AnnieJ's mobile device integrated services digital network (MSISDN) number may be appended to the name AnnieJ to yield a unique name, or any universal unique identifier may be appended to a name of a peersona to yield a universal unique name for the peersona. The name may be appended or bound to the UUID of the peersona. Thus, a user's full Peerouette-Network identity would be the {peersona name, peersonaIdentity} pairing. To protect privacy of a user, a user's name for the peersona may not be presented to other users of the Peerouette-Net but only those which are authorized to know, search, and view the name for Annie J. Su's peersona. In such a manner, a user may remain unknown or anonymous to other users of the Peerouette-Net. A user may securely add a unique string to the peersona name that is only available to authorized users, and for which lookups will only succeed if the user looking up the peersona has been given lookup access by the named peersona network entity. Typically, an MSIDN, a home address, a secret and personal phrase, etc. may be used as a unique string. Furthermore, Peersona Central Services can certify this name as unique. If a user has been authorized to receive a response from a lookup of the user's peersona, a lookup such as of AnnieJ+441923895555, where +441923895555 is AnnieJ's MSISDN number, would yield the peersona Peerouette-Net address that includes the IP address of the modulator and the peersonaIdentity of the peersona, such as of Annie J. Su's peersona. When a peersona is registered, descriptive information may be required such as the user's name, a nickname for the peersona, a mobile phone number, an email, and other related or similar information. This information would be stored with the peersonaIdentity generated for the peersona. To protect the privacy of a user, the user's name for the peersona may not be presented to other users of the Peerouette-Net but only those that are authorized to know, search, and view the name for Annie J. Su's peersona that includes the unique, descriptive information. In such a manner, a user may remain unknown or anonymous to other users of the Peerouette-Net. Such information is to be understood as examples and not limiting examples of information presented to register a peersona. With respect to FIG. 8, a dashed line is shown to represent that Bill Jäger is part of Annie J. Su's Friends Network. This Friends Network may be a private peersona community of Annie J. Su which identifies particular peersonas or users are common to Annie J. Su's Friends Network, thereby possibly providing each of those individuals access to the name of Annie J. Su's peersona and the ability to search for Annie J. Su's peersona and retrieve the modulator IP address and peersonaIdentity for Annie J. Su's peersona on the Peerouette-Net.

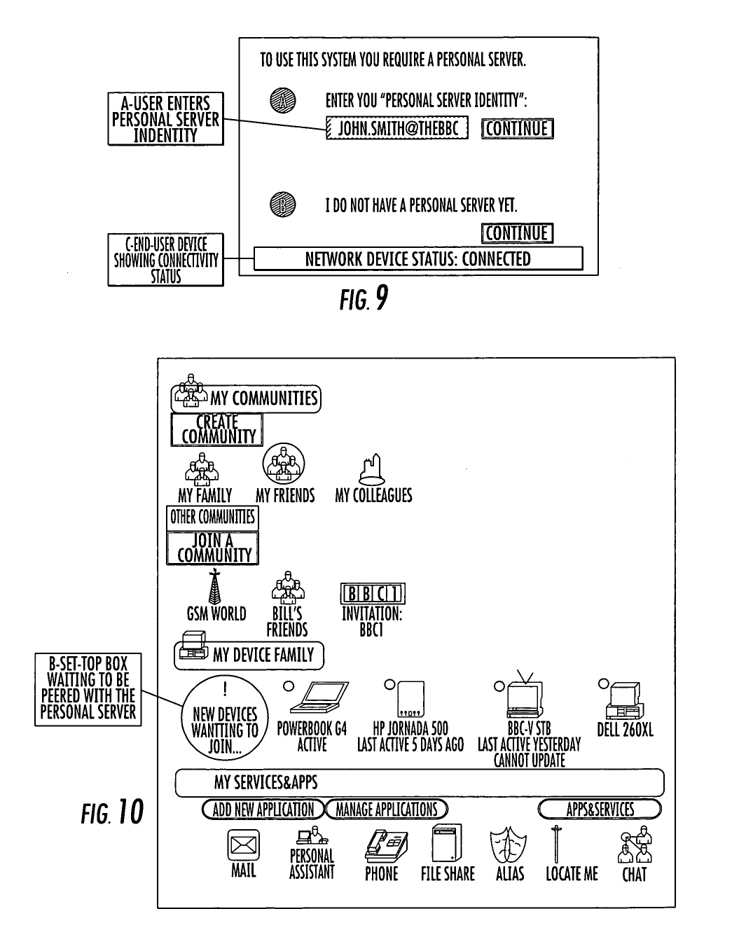

FIG. 9 is a device connection portal, typically generated by an edge-peer connecting to a peersona and displayed on the edge-peer for the user, using web access to a peersona of an embodiment of the present invention. After creating a peersona, a user may wish to associate or connect end-user devices or edge-peers with the user's peersona. If no peersona exists when an end-user device connects to the Peerouette-Net, the user would be able to select that they do not have a Personal Server or peersona yet and such configuration would continue. Where a user does have a Personal Server identity, after connecting the end-user device to the Peersona-Net, the user may select to continue the process of connecting or associating the end-user device with the user's peersona. The user may access the user's Personal Server or peersona through a web interface or other interface either through the end-user device or separately. If through the end-user device attempting to be connected or associated with the peersona, the user would likely be required to enter a password to ensure that the user of the peersona is actually connecting or activating the new end-user device. If the user is accessing his or her Personal Server or peersona such as through a web access, a Personal Server Management Console may be used to show the user that a new device is waiting to be peered with his or her Personal Server. A Personal Server Management Console may be a user interface to access, view, control, and modify a peersona. For example, the Personal Server Management Console portal shown in FIG. 10 allows a user to view the communities and devices associated with his or her peersona and to select functions or services available for his or her peersona, such as creating or joining a community, adding a new application, managing an application, and accessing services such as mail, personal assistant, phone, file sharing, and chat.

FIG. 10 shows a community, device connection, and services and application portal, typically generated by a Personal Server and displayed on an end-user device or through peersona web access portal, of to a peersona seen from a Personal Server Management Console of an embodiment of the present invention. If a request is made from an end-user device as shown in FIG. 9 where the user does not authorize the connection or association directly from the end-user device, the user may need to access his or her Personal Server Management Console such as shown in FIG. 10 to identify that a new device is waiting or has requested to be associated with the user's peersona. For example, a spouse may request his or her end-user device be associated with a family peersona controlled by his or her spouse. By requiring a password known only to the user of the peersona, security may prevent someone from associating an unauthorized device with a peersona and to support control of the devices associated with a peersona. Thus, embodiments of the present invention may be used to allow authorization of association of an edge-peer with a peersona from an end-user device and embodiments to allow a request for association between an edge-peer and a peersona where the user of the end-user device does not have supervisory control of the peersona.

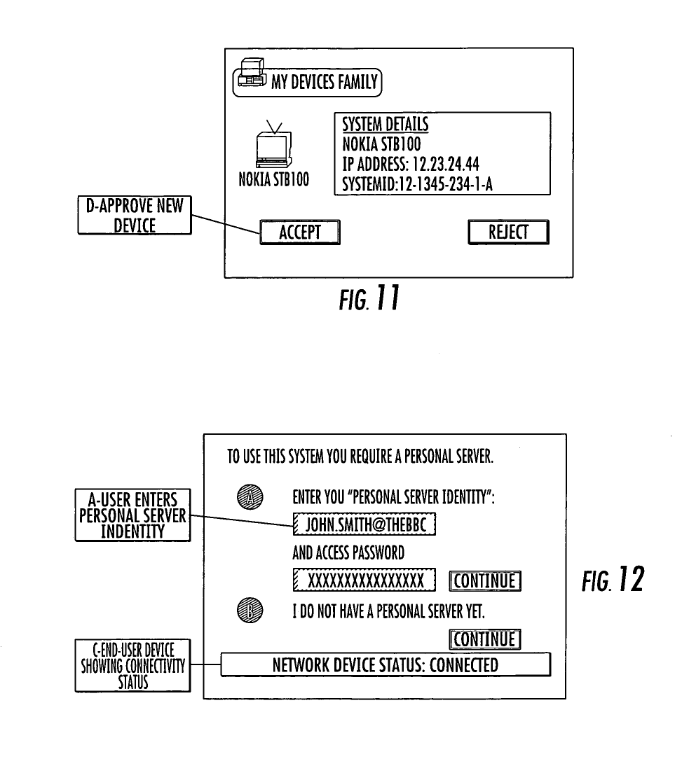

FIG. 11 is an acceptance portal, typically generated by an edge-peer connecting to a peersona and displayed on the edge-peer or generated a Personal Server Management Console and displayed through a peersona web access portal, of a device connection to a peersona of an embodiment of the present invention. From the Personal Server Management Console of FIG. 10, a user may select to authorize or reject a request for association of a new device as shown in FIG. 11. By comparison, FIG. 12 is a device connection portal, typically generated by an edge-peer connecting to a peersona and displayed on the edge-peer or generated a Personal Server Management Console and displayed through a peersona web access portal, requesting a peersonaIdentity and password for a connection to a Personal Server of an embodiment of the present invention. In this case, the user of the peersona is authorizing the connection of the new end-user device to the peersona by entering both the Personal Server identity and an access password to authorize the association. One of ordinary skill in the art will understand that various types of requests and authorizations may be used for associating an end-user device with a peersona.

FIG. 13 is a block diagram of two stages of the process of service or content configuration of an embodiment of the present invention. By using a separate Personal Server or peersona located on a modulator and end-user devices or edge-peers, the services and content used and provided to the user are performed or passed through two stages. The first stage is from a service route node or other external server, such as another peersona stored by the modulator or an external content server, to the Personal Server. The second stage is from the Personal Server to the end-user device. In order to ultimately reach the user, a content or service function may be performed and/or produced by a service or content provider route node system and consumed by the Personal Server, and then performed and/or produced by the Personal Server system and consumed by the end user. This layered approach to an always-on Personal Server to represent the peersona and user interaction through end-user devices presents two-stage content download, two-stage application upgrade or update, two-stage application execution, and two-stage configuration management. Various other two-stage functionalities may be performed by the Personal Server and end-user devices of embodiments of the present invention. By way of further example, in a two-stage content download, content may originally be presented in full to the Personal Server and then consumed in real time by an end-user device rather than downloading the entire multimedia content file to the end-user device. However, by downloading the entire multimedia file to the Personal Server, the user will be able to share the content with other peersonas or retrieve the content when using other end-user devices. In some respects, the Personal Server is a storage medium for content of a single user in order to allow the user to be able to access all of the user's peersona information, data, and content from a single source with various end-user devices. However, in addition to a single storage source, the Personal Server provides increased reliability for the Peerouette-Net by presenting an always-on network representation of the user in the form of the peersona. In addition, by separating the Personal Server from the end-user device and representing the user in the network by the peersona of the Personal Server, features such as distributing content, upgrading or updating computer program codes such as application software or operating systems, and configuration management of the network and entities thereof is simplified by allowing control servers of the broader Peerouette-Network environment to communicate with the Personal Server without being required to communicate with an end-user device which may or may not be available at the time of the upgrade. Further, by presenting multiple Personal Servers on a single modulator entity, control servers of the broader Peerouette-Network are able to ultimately contact fewer entities by only being required to contact each of the modulators rather than having to contact each of the Personal Servers or every end-user device on the entire system. Once the upgrade, content, configuration, or other control functionality has been presented to the modulator, the modulator can then perform any further required functionality such as determining whether or not each of the associated end-user devices of the Personal Servers resident on the modulator need to be upgraded or modified in any way based upon the information provided originally to the modulator. Similarly, a two-stage application execution may allow certain software modules to only be required to be resident on the Personal Server and not required to be downloaded and run on the end-user devices.

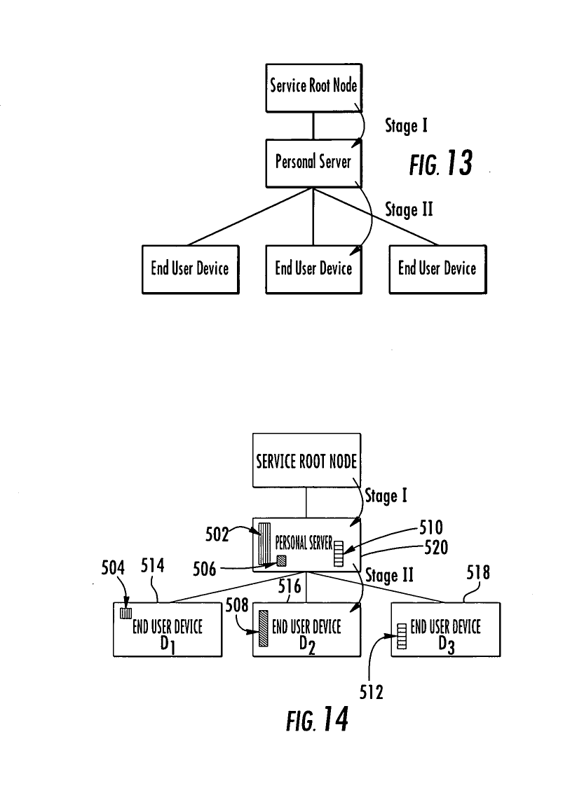

FIG. 14 is a block diagram of two stages of computer program code updating and service configuration management of an embodiment of the present invention. As described with reference to FIG. 13, by separating the Personal Server and peersona from the end-user devices, all activity which must be performed on the end-user device passes through the Personal Server, but changes to the Personal Server do not necessarily affect each or any of the end-user devices. As shown in FIG. 14, a Personal Server receives data or software bundles or modules 502, 506, 510. In the example of FIG. 14, each of the end-user devices is associated with one of the data or software bundles or modules. For example, a first end-user device D₁ 514 may include computer program code 504 associated with computer program code 502 on the Personal Server 520. The computer program code 504 on end-user device D₁ 514 may be a portion of the computer program code 502 on the Personal Server 520 which has been partially downloaded by the end-user device D₁ 514, or may be an associated segment of a software application which has been partitioned or divided between the Personal Server 520 and the end-user device D₁ 514. A second end-user device D₂ 516 may include multimedia data 508 associated with multimedia data 506 on the Personal Server 520. When the end-user device D₂ 516 connects to the Personal Server 520, the Personal Server 520 may identify that a download of multimedia content was interrupted when the end-user device D₂ 516 was previously disconnected from the Personal Server 520. Thereby, the Personal Server 520 may download or transfer the remaining portion of the content 506 received by the Personal Server 520. Alternatively, the end-user device may determine whether or not it wishes to continue the download of the interrupted content download and retrieve the remaining media content 506 from the Personal Server 520. A third end-user device D₃ 518 may include computer program code 512 which is a different version from the computer program code or content 510 on the Personal Server 520. The Personal Server 520 may have received the computer program code 510 as an update or upgrade to the computer program code 512 previously provided to the Personal Server 520 and subsequently to the end-user device D₃ 518. When the end-user device D₃ 518 connects to the Personal Server 520, the Personal Server 520 may identify that the end-user device D₃ 518 maintains an older version of the computer program code 510 recently received by the Personal Server 520 and download or replace the computer program code 512 on the end-user device D₃ 518 with the newer computer program code 510 on the Personal Server 520.

FIG. 15 is a request to backup an end-user device onto a Personal Server, typically generated by an edge-peer connecting to a peersona and displayed on the edge-peer or generated a Personal Server Management Console and displayed through a peersona web access portal, of an embodiment of the present invention. Backups of end-user devices may be performed automatically, with or without prompting the user for confirmation, such as after a period of time since the previous backup of the end-user device. For example, if an end-user device was backed-up one week ago, and is scheduled to be backed-up once a day but has not been online for one week, the first day that the end-user device connects after the elapsed period of time when the backup should occur, the Personal Server may automatically request or perform a backup of the end-user device. Further, a user may be able to select or confirm a backup process to occur. For example, a user may be able to connect an end-user device to a Personal Server and select an option to backup the end-user device onto the Personal Server at that time. As shown in FIG. 15, an end-user device has been connected to a Personal Server and, either automatically with confirmation or by selection by the user, a backup option has been initiated. The user then has the ability to select or confirm backup of the end-user device at that time.

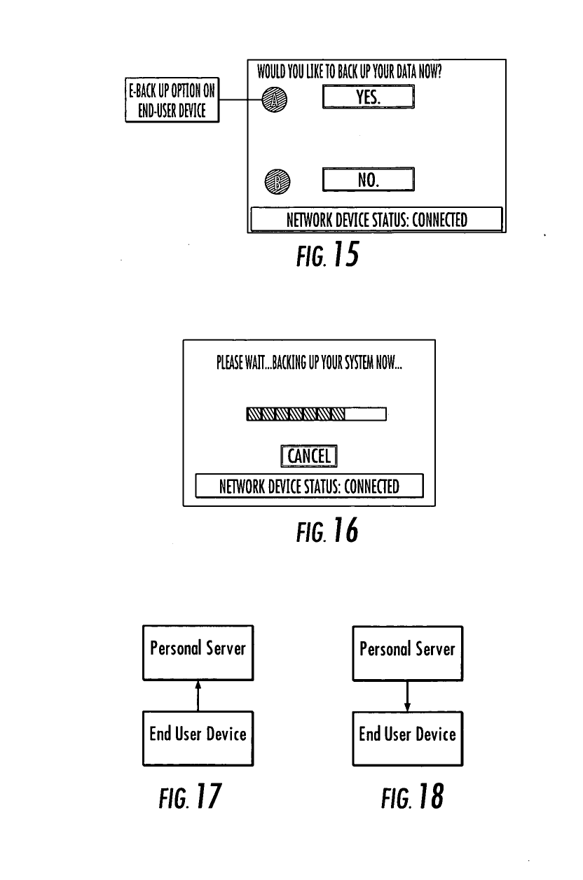

FIG. 16 is a status view during backup of an end-user device onto a Personal Server, typically generated by an edge-peer connecting to a peersona and displayed on the edge-peer or generated a Personal Server Management Console and displayed through a peersona web access portal, of an embodiment of the present invention. If a user had selected “yes” to the request to backup an end-user device at the time as shown in FIG. 15, the end-user device may present the user with a view that shows the backup status of the end-user device onto the Personal Server.

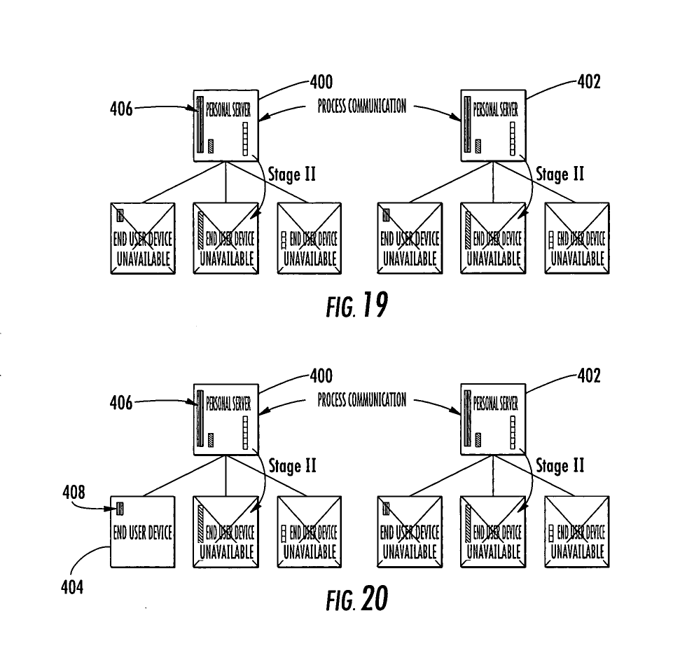

FIG. 17 is a block diagram of a backup of an end-user device onto a Personal Server of an embodiment of the present invention. FIG. 17 shows that the information of the end-user device is stored or backed-up onto the Personal Server such that it may be maintained on the Personal Server either for restoration of the end-user device or transfer of the information that was on the end-user device which was backed-up to the Personal Server onto a new end-user device as shown and described more fully with reference to FIG. 18.

FIG. 18 is a block diagram of restoration of an end-user device from a Personal Server of an embodiment of the present invention. With reference to FIGS. 15, 16, and 17, FIG. 18 shows that the data of a backup of an end-user device onto a Personal Server may be restored or transferred onto an end-user device from the Personal Server. For example, a user may lose a device or a device may malfunction or crash. If the information from the end-user device which has been lost or has malfunctioned has been previously backed-up onto the user's Personal Server, the information from the end-user device may be restored onto a replacement end-user device or restored in order to repair a malfunctioned device. A user may be able to choose whether or not an end-user device which has crashed or been lost may be restored from a backup of an end-user device on a Personal Server. For example, a user who purchases a new mobile phone may or may not want to restore and reconfigure the new mobile phone with the information and configurations of a previous mobile phone. An example use of this type of end-user device backup may be a user who acquires a new mobile phone once a month and wants to continue transferring the address settings and other settings or features such as ring tones from the prior mobile phone onto the new mobile phone.

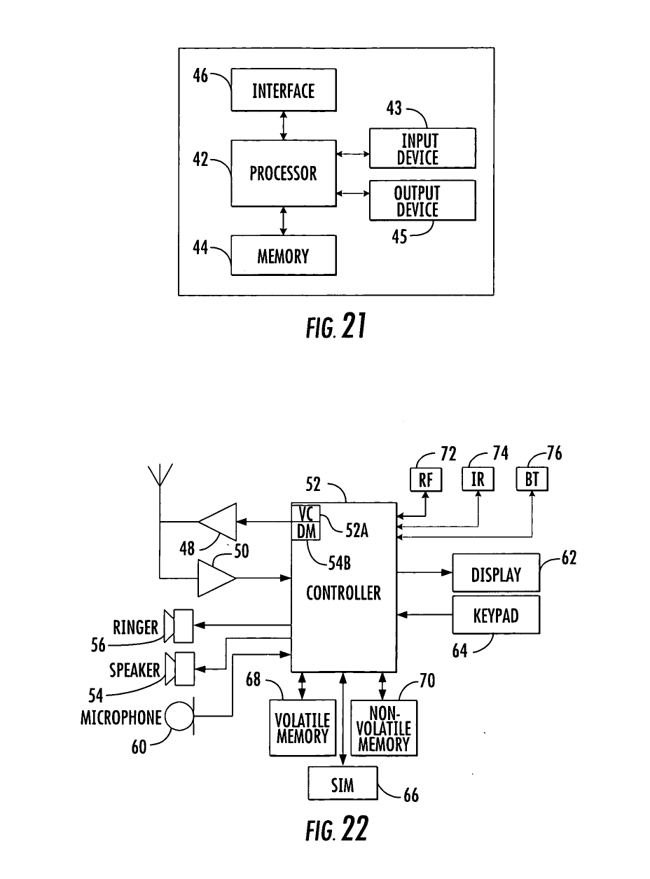

As previously described, peersonas, the network identity of users, reside on Personal Servers. The Personal Servers are stored on modulators which are connected 24/7 as always-on and can function irrespective of the connectivity of end-user devices or edge-peers. Accordingly, FIG. 19 is a block diagram of Personal Servers communicating for application execution or providing services for peersonas while end users and end-user devices of the peersonas are unavailable to the Personal Servers according to an embodiment of the present invention. FIG. 19 shows that a first Personal Server 400 and a second Personal Server 402 are able to communicate even when no edge-peers are available to the Personal Servers. The Personal Servers may be able to share information, data, or content stored on the Personal Server. A peersona of a Personal Server may be searched and discovered when edge-peers are disconnected. FIG. 20 is a block diagram of an edge-peer of a peersona becoming active on a Personal Server of an embodiment of the present invention. When an edge-peer becomes available to the Personal Server by connecting to the Personal Server and the peersona, the modulator or Personal Server process may inform the now active device of new events that took place during the time while the end-user device was inactive or unavailable. For example, a user's Personal Server 400 may identify that multimedia content 406 was received from a second Personal Server 402 while the end-user device 404 was off-line. Accordingly, the user's Personal Server 400 may request of the user of end-user device 404 if the content 406 should be downloaded to the end-user device 404 such as to supplement a prior portion of content 408 downloaded to the end-user device. Additionally or alternatively, the user's Personal Server 400 may request of the user whether the content 406 should be retained on the user's Personal Server 400 or downloaded to the end-user device, or whether the user might want to view or otherwise execute the multimedia content 406 stored on the user's Personal Server 400, such as in a real-time viewing function on the end-user device 404. However, for some copyright protected content, a user may not be permitted to store the content on an end-user device, but rather may only be able to display, play, or otherwise access the content from the end-user device. This may depend upon the digital rights management policies under which the content was acquired and removed from content escrow to the appropriate peersona community sharable content store.

Reference is now made to FIG. 21, which illustrates a block diagram of an entity capable of operating as a network node (e.g., Personal Server, Modulator, Regional Peerouette-Net Authority, Hosting Central Server, Content Server, etc.) within the broader definition of the Peerouette-Network in accordance with one embodiment of the present invention. Although shown as separate entities, in some embodiments, one or more entities may support one or more of the network nodes, logically separated but co-located within the entity or entities, such as multiple Personal Servers located on a common modulator. An edge-peer is not such a network node entity. The roles of edge-peers and network nodes are distinct.

As shown, the entity capable of operating as a network node can generally include a processor, controller, or the like 42 connected to a memory 44. The processor can also be connected to at least one interface 46 or other means for transmitting and/or receiving data, content, or the like such as a network connection or wireless connection. The memory 44 can include volatile and/or non-volatile memory and typically stores content, data, or the like. For example, the memory 44 typically stores computer program code such as software applications or operating systems, information, data, content, or the like for the processor 42 to perform steps associated with operation of the entity in accordance with embodiments of the present invention. The memory 44 may, for example, store computer program code such as a edge-peer-to-peersona communication protocol or a media content transcoder to decode content from one coding scheme of downloaded content and to encode the content into another coding scheme. Also, for example, the memory 44 typically stores content transmitted from, or received by, the network node. Memory 44 may be, for example, random access memory (RAM), a hard drive, or other fixed data memory or storage device. The processor 42 may receive input from an input device 43 and may display information on a display 45. Where the entity provides wireless communication, such as a mobile network, the processor 42 may operate with a wireless communication subsystem (not shown), such as a cellular transceiver, in the interface 46. Mobile network includes a cellular network, and may also include a private network using such communication technologies as IR, BT, or the like. One or more processors, memory, storage devices, and other computer elements may be used in common by a computer system and subsystems, as part of the same platform, or processors may be distributed between a computer system and subsystems, as parts of multiple platforms.

FIG. 22 illustrates a functional diagram of a mobile device that may operate as a mobile terminal 32 and, as such, an end-user device or edge-peer according to embodiments of the invention. It should be understood, that the mobile device illustrated and hereinafter described is merely illustrative of one type of mobile terminal that would benefit from the present invention and, therefore, should not be taken to limit the scope of the present invention. While several embodiments of the mobile device are hereinafter described for purposes of example, other types of mobile terminals, such as portable digital assistants (PDAs), pagers, laptop computers, and other types of voice and text communications systems, can readily employ the present invention.

The mobile device includes a transmitter 48, a receiver 50, and a controller 52 that provides signals to and receives signals from the transmitter 48 and receiver 50, respectively. These signals include signaling information in accordance with the air interface standard of the applicable cellular system, and also user speech and/or user generated data. In this regard, the mobile device can be capable of operating with one or more air interface standards, communication protocols, modulation types, and access types. More particularly, the mobile device can be capable of operating in accordance with any of a number of 1G, 2G, 2.5G and/or 3G communication protocols or the like. For example, the mobile device may be capable of operating in accordance with 2G wireless communication protocols IS-136 (TDMA), GSM, and IS-95 (CDMA). Also, for example, the mobile device may be capable of operating in accordance with 2.5G wireless communication protocols GPRS, Enhanced Data GSM Environment (EDGE), or the like. Some narrow-band AMPS (NAMPS), as well as TACS, mobile devices may also benefit from embodiments of the present invention, as should dual or higher mode mobile devices (e.g., digital/analog or TDMA/CDMA/analog phones).

It is understood that the controller 52, such as a processor or the like, includes the circuitry required for implementing the video, audio, and logic functions of the mobile device. For example, the controller may be comprised of a digital signal processor device, a microprocessor device, and various analog to digital converters, digital to analog converters, and other support circuits. The control and signal processing functions of the mobile device are allocated between these devices according to their respective capabilities. The controller 52 thus also includes the functionality to convolutionally encode and interleave message and data prior to modulation and transmission. The controller 52 can additionally include an internal voice coder (VC) 52A, and may include an internal data modem (DM) 52B. Further, the controller 52 may include the functionally to operate one or more software applications, which may be stored in memory.

The mobile device also comprises a user interface including a conventional earphone or speaker 54, a ringer 56, a microphone 60, a display 62, and a user input interface, all of which are coupled to the controller 52. The user input interface, which allows the mobile device to receive data, can comprise any of a number of devices allowing the mobile device to receive data, such as a keypad 64, a touch display (not shown), or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys.

The mobile device can further include an IR transceiver 74 or another local data transfer device so that data can be shared with and/or obtained from other devices such as other mobile devices, car guidance systems, personal computers, printers, printed materials including barcodes, and the like. The sharing of data, as well as the remote sharing of data, can also be provided according to a number of different techniques. For example, the mobile device may include a radio frequency (RF) transceiver 72 capable of sharing data with other radio frequency transceivers, and/or with a Radio Frequency Identification (RFID)) transponder tag, as such is known to those skilled in the art. Additionally, or alternatively, the mobile device may share data using Bluetooth (BT) brand wireless technology developed by the Bluetooth Special Interest Group and a BT transceiver 76. Further, the mobile device may be capable of sharing data in accordance with any of a number of different wireline, proximity, and/or radio wave networking techniques, including LAN and/or WLAN techniques.

The mobile device can also include memory, such as a subscriber identity module (SIM) 66, a removable user identity module (R-UIM) (not shown), or the like, which typically stores information elements related to a mobile subscriber. In addition to the SIM, the mobile device can include other memory. In this regard, the mobile device can include volatile memory 68, as well as other non-volatile memory 70, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile device. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application, such as a software program or modules for an application, and may store an update for computer program code for the mobile device.

One of ordinary skill in the art will recognize that the present invention may be incorporated into software systems and subsystems, as well as various other applications, and embodied as or incorporated into a network or group of networks. In each of these systems as well as other systems, including dedicated systems, capable of hosting the system and method of the present invention as described above, the system generally can include a computer system including one or more processors that are capable of operating under software control to provide the techniques described above. For example, a network node as shown in FIG. 21 may include a computer system including memory, a processor, and interface.

It will be understood that each block, or step, or element of the figures of the present invention, and combinations of blocks and/or elements in the figures of the present invention, support combinations of means and combinations of steps for performing the specified functions. For example, memory 44 may include more than one physical device under the control of more than one processor. Similarly, it will be understood that each block, or step, or element of the figures of the present invention, and combinations of blocks and/or elements in the flowchart, can be implemented by computer program instructions. For example, the connection portals of FIGS. 9, 11, and 12, may be generated by computer program instructions stored on an edge-peer, a peersona, or both. These computer program instructions may be loaded onto a computer or other programmable apparatus to produce a machine, such that the instructions which execute on the computer or other programmable apparatus create means for implementing the functions specified in the flowchart block(s) or element(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or element(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or element(s). It will also be understood that each block or element of the flowchart, and combinations of blocks and/or elements in the flowchart, can be implemented by special purpose hardware-based computer systems which perform the specified functions or steps, or combinations of special purpose hardware and computer instructions.

Herein provided and described are improved systems and methods for a personal server and associated network for P2P and cellular technologies. The present invention provides peersonas for users that may reside on always-on Personal Servers stored on modulators which are the hardware element that may be connected and running 24/7 on a P2P network such as the Peerouette-Network. Multiple peersonas and Personal Servers may reside on a single modulator, and such modulators may be organized into sites and by regions to organize the routing of information between modulators and the Personal Servers and peersonas thereof. In addition, the present invention provides that a user, represented by a peersona on a Personal Server, may associate one or many end-user devices, or edge-peers, with the peersona of the user. These edge-peers are one means by which a user may interact with his or her peersona and, therefore, the P2P network. By separating the presence of a user on the P2P network as the peersona of a user and the edge-peers, the P2P network maintains stability and reliability previously unavailable with traditional P2P networks using end-user devices as entities of users on the network. Thus, edge-peers are not network nodes on the Peerouette-Net, and do not act as either a modulator or a Personal Server or peersona.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A network system, comprising:
at least two interconnected modulators, wherein each of said modulators comprises at least one peersona;
at least two edge-peers, wherein each of said edge-peers is associated with one of said peersonas.

2. The system of claim 1, wherein at least one of said peersonas is associated with at least two of said edge-peers.

3. The system of claim 1, wherein at least one of said modulators comprises at least two peersonas.

4. The system of claim 1, further comprising:
at least one site, wherein said site comprises at least one modulator; and
at least one region, wherein said region comprises at least two sites.

5. The system of claim 4, wherein one of said modulators of said site is a local modulator of said site to coordinate communication with and between modulators of said site and provide routing within said site as a site routing authority.

6. The system of claim 1, further comprising:
at least one region, wherein said region comprises at least two modulators; and
a regional authority associated with said region and interconnected with each of said modulators in said region.

7. The system of claim 1, wherein at least two of said peersonas are organized in a peersona community.

8. The system of claim 7, wherein one of said peersonas of said peersona community is the creator of said peersona community.

9. A peersona system, comprising:
a modulator;
a peersona stored by said modulator; and
at least one edge-peer associated with said peersona.

10. The peersona system of claim 9, wherein said peersona stores at least some of the content for said edge-peer.

11. The peersona system of claim 9, wherein said peersona comprises a content escrow that stores at least some of the content for said peersona.

12. The peersona system of claim 11, wherein said content escrow maintains said content until digital rights management clearance for access or sharing of said content in said content escrow.

13. The peersona system of claim 9, wherein said peersona is capable of communicating with at least one of said edge-peers using a peersona-edge-peer communication protocol.

14. The peersona system of claim 9, wherein said edge-peer is selected from the group consisting of a mobile phone, a pager, an electronic gaming system, a portable multimedia system, a personal music system, a personal digital assistant, a personal-portable electronic device, a personal computer, a television set device, and a dedicated device.

15. A modulator system, comprising:
a memory segmented to store data representing at least one user entity; and
a processor interoperably coupled to said memory and capable of generating a network connection and an end-user device connection, and wherein said processor is further capable of transferring information to and from said memory with at least one end-user device.

16. The modulator system of claim 15, further comprising a site-wide modulator map that lists active modulator bindings at a site of the modulator system.

17. The modulator system of claim 15, further comprising a bandwidth monitoring module to monitor and record bandwidth usage of said network and end-user device connections.

18. A method of performing networking, comprising the steps of:
creating a plurality of peersonas, wherein each of said peersonas represents one user of a network, and wherein each of said peersonas is resident on one of at least two modulators;
internetworking said modulators; and
associating at least one edge-peer with each of said peersonas.

19. The method of claim 18, further comprising the step of dividing computer program code for an application or a service of one of said edge-peers between said edge-peer and said peersona associated with said edge-peer.

20. The method of claim 19, further comprising the steps of:
distributing updated computer program code to said modulators; and
updating computer program code of at least one of said peersonas using at least a portion of said updated computer program code, wherein said updating of computer program code of said peersona updates at least a portion of divided computer program code for an application or a service of said peersona wherein an associated edge-peer includes at least a portion of divided computer program code for the same application or service.

21. The method of claim 20, further comprising the step of updating at least a portion of divided computer program code of an edge-peer associated with said peersona, wherein said updated divided computer program code is for one of the computer program codes selected from the group of: (1) the same application or service as the updated divided computer program code of said peersona, (2) the operating system of said edge-peer, and (2) the communication protocol between said edge-peer and said associated peersona.

22. The method of claim 18, further comprising the steps of:
distributing updated computer program code to said modulators;
updating computer program code of said peersonas using at least a portion of said updated computer program code; and
updating computer program code of at least one of said edge-peers using at least a portion of said updated computer program code.

23. The method of claim 22, further comprising the step of inspecting information of computer program code of said edge-peers to determine whether computer program code of said edge-peers is to be updated with at least a portion of said updated computer program code.

24. The method of claim 18, further comprising the step of performing configuration management of at least one of said modulators, peersonas, or edge-peers.

25. The method of claim 24, wherein performing configuration management includes deploying application or service computer program code or modifying at least one setting.

26. The method of claim 25, wherein deploying computer program code comprises deploying an application or service computer program code, an operating system for an edge-peer, or a communication protocol between an edge-peer and a peersona.

27. The method of claim 18, further comprising the step of storing a peer-to-peer computer program code for said network in said peersonas.

28. The method of claim 18, further comprising the step of storing an edge-peer-to-peersona communication protocol computer program code in said edge-peers, wherein said edge-peer-to-peersona communication protocol computer program code facilitates communication between said edge-peers and said associated peersonas of said edge-peers.

29. The method of claim 18, further comprising the step of communicating between two personas of at least one modulator, wherein each of the edge-peers associated with at least one of said peersonas is at least temporarily disconnected from or unavailable to said peersona.

30. The method of claim 18, further comprising the step of distributing at least one data file to at least one of said modulators, said peersonas, or said edge-peers.

31. The method of claim 30, wherein distributing said at least one data file comprises distributing at least one data file comprising multimedia content or information associated with digital rights management of a user.

32. The method of claim 31, further comprising determining at least one source of said content by using a peersona community silent chat protocol.

33. The method of claim 18, further comprising the step of backing up one of said edge-peers onto said peersona associated with said backed-up edge-peer to create a backup of said backed-up edge-peer.

34. The method of claim 33, further comprising the step of restoring an edge-peer from said backup of said backed-up edge-peer, wherein said resorted edge-peer is said backed-up edge-peer or a different edge-peer.

35. The method of claim 18, wherein the step of internetworking said modulators includes the step of requesting a site-wide modulator map.

36. The method of claim 35, wherein the step of internetworking said modulators when there are no other registered modulators at the site of a requesting modulator includes requesting notification from a central host of registrations of other modulators at the site of the requesting modulator.

37. The method of claim 18, further comprising the step of messaging a sequential keep-alive token ring of said modulators to update the site-wide modulator map at each of said modulators, wherein said messaging begins either with notification by a central host to a registered modulator of registration of a modulator or periodically by a registered modulator.

38. The method of claim 18, further comprising the step of delivering at least one content file simultaneously or pseudo-simultaneously to two or more edge-peers of one of said peersonas by said peersona of said edge-peers.

39. The method of claim 18, further comprising the step of accessing content on at least one of said edge-peers.

40. The method of claim 39, wherein said accessing comprises at least one of viewing, playing, or displaying said content.

41. The method of claim 39, wherein said accessing comprises simultaneously accessing said content on at least two edge-peers.

42. The method of claim 41, wherein said accessing content on at least two edge-peers comprises accessing said content using at least two different coding schemes.

43. The method of claim 42, wherein said accessing content on at least two edge-peers comprises using one coding scheme on at least two of said edge-peers and a second coding scheme on at least another of said edge-peers.

44. The method of claim 41, wherein said accessing content on at least two edge-peers comprises using one coding scheme on said edge-peers.

45. The method of claim 18, further comprising the step of transcoding at least part of at least one content data file for at least one-edge peer, wherein said transcoding is performed by one of said modulator.

46. The method of claim 45, wherein said transcoding comprises transcoding all of at least one content data file.

47. The method of claim 45, wherein said transcoding is performed by a processor of one of said modulators.

48. The method of claim 47, wherein at least one of said edge-peers is associated with one of said peersonas resident on said modulator performing said transcoding.

49. The method of claim 47, wherein at least one of said edge-peers is associated with one of said peersonas not resident on said modulator performing said transcoding.

50. The method of claim 18, further comprising the steps of:
acquiring digital rights for content for a first community; and
providing said content from a modulator or peersona of a second community to at least one modulator or peer of said first community.

51. The method of claim 50, further comprising the step of transcoding said content by one of said modulators of said second community.
